(19) United States
(12) Patent Application Publication
(10) Pub. No.: US 2021/0292069 A1
(43) Pub. Date: Sep. 23, 2021

(54) PACKAGE WITH AN OPENING COVERED BY RESEALABLE LABEL FLAP

(71) Applicant: Wojciech WAJDA, Lusówko (PL)

(72) Inventor: Wojciech WAJDA, Lusówko (PL)

(21) Appl. No.: 17/340,003

(22) Filed: Jun. 5, 2021

Related U.S. Application Data
(63) Continuation of application No. PCT/PL2019/000115, filed on Dec. 5, 2019.

(30) Foreign Application Priority Data
Dec. 5, 2018 (PL) P.428069

(51) Int. Cl. B65D 75/58; B65D 83/08

(52) U.S. Cl. CPC B65D 75/5838; B65D 83/0805

(57) ABSTRACT

Package with an opening covered by resealable label flap comprises a container body (1) which has a dispensing opening (1a) on its top surface and a rigid reinforcing element (2) adhered to the top surface of the container body (I) and surrounding the opening (1a) in the form of a sheet of PET foil, as well as a flexible top element (3) adhered to the reinforcing element (2), in the form of a sheet of BOPP foil and a flap covering tightly the dispensing opening (1a). The hinge line (4) is formed by a series of short cut lines (6) passing between the end fragments of long cut lines (5) rounded to the outside of the base surface of the flap, towards the sides of the combination of the reinforcing element (2) with the top element (3).

### CROSS REFERENCE TO RELATED APPLICATIONS

This application is a continuation application under 35 U.S.C. 120 which claims the priority of International Patent Application No. PCT/PL2019/000115, filed Dec. 5, 2019, and of Polish Patent Application No. P. 428069, filed on Dec. 5, 2018, the contents of each of which are hereby incorporated by reference.

### FIELD OF INVENTION

This disclosure relates to a packaging with an opening covered by resealable label flap, intended for packaging and distribution of articles contained therein, in particular in the form of tissues.

### BACKGROUND

From the description of the European patent number EP 2202176 B1, a solution for a multiple-stick label flap placed to cover the opening of a product package containing removable articles, to cover the package opening. The label flap has a base layer extending between a first and a second end. The base layer has a first adhesive on the bottom face surface that permits repeated application and separation of the base layer relative to the package. The base layer has a starting tab to permit the removal of the base layer from the package. The top layer is fixed to the base layer and has a second adhesive on the bottom face surface that permanently fixes the top layer to the top face surface of the base layer. The base layer and the first adhesive on its bottom face surface are formed with a slit that defines a hinge for enhancing separation of the base and top layers from the package upon manipulation of the starting tab. The slit defining the hinge extends completely through the base layer and the first adhesive. The slit is positioned near the first end of the base layer, and the starting tab is positioned at the opposite second end of the base layer. The base layer and the top layer form the flap portion with the end of fixing and the removable end including the starting tab. Information may be printed on at least one base layer and top layer. The resealable label flap may include a frame that extends substantially around the package opening. The top layer is coextensive with the base layer.

The first adhesive is preferably a removable pressure sensitive adhesive, and the second adhesive is a permanent pressure sensitive adhesive. In another embodiment of disclosure, a resealable label flap is placed to cover the opening in the package containing the removable articles. The label flap has a base layer extending between a first and second end. The base layer has a first adhesive on the bottom face surface that permits repeated application and separation of the base layer relative to the package. The base layer has a starting tab that permits the base layer to be removed from the package. The top layer is fixed to the base layer and has a second adhesive on the bottom face surface that firmly fixes the top layer to the top face surface of the base layer preventing them from separating. The base layer and first adhesive are formed with a slit defining the hinge. The base layer, first adhesive, top layer and second adhesive are formed to include a flap portion fixed tiltably around the hinge to a frame extending substantially around the flap portion and reinforcing the package.

From the description of the GB patent number GB2539331 B, a solution is known for the resealable label flap containing a bottom layer of flexible material and a top layer of rigid material. The bottom and top layers have an adhesive layer on the bottom surface, and the adhesive on the top layer to adhere this layer to the bottom layer. In order to outline the flap portion, the sheet is cut through both layers, whereas the uncut edge section remains within the hinge area. The top layer within outer area surrounding the flap portion ends approximately at the hinge line, although it may extend beyond to a greater or lesser extent for additional stability. There is no adhesive on the underside of the flap, or the adhesive is covered or neutralized, but the remaining flap portion has a sticky adhesive to adhere to the package again. The bottom layer can be made of a durable but flexible polymer, such as polypropylene (PP), about 50 μm thick, the top layer of the same, the top layer of the same or, preferably, another material, such as polystyrene (PS) or PET, and preferably at least two or three times thicker about 150 μm, the top layer of the same. Both are laminated with a suitable acrylic-based adhesive, and any ordinary adhesive may be used for the purpose of resealable label flap under the base layer. The flap may have a substantially rectangular, rounded, elliptical, oval or ogival shape, although the hinge will generally be a straight line.

The description of the invention according to the international application WO 2017/036984 A1 unveils a construction of the package comprising a container body having a top surface, a dispensing opening on said top surface, and a rigid reinforcing element adhered to the top surface of the container body and surrounding the dispensing opening, said reinforcing element being preferably in the form of a sheet of PET or OPS or PP foil, wherein said reinforcing element has a closing flap which can cover tightly the dispensing opening, said closing flap having a base surface and being a fragment of the reinforcing element separated by long cut lines running towards a hinge line, said long cut lines passing at least along two sides of the reinforcing element and having end fragments rounded to the outside of the base surface of the flap thereby forming roundings having a radius R1, wherein the hinge line is formed by a series of short cut lines passing between the end fragments of said long cut lines, said series of short cut lines comprising extreme cut lines and inner cut lines, wherein the extreme cut lines in said series of short cut lines, on the side of said long cut lines, have first roundings, whereas the opposite ends of the extreme cut lines have second roundings defined by a radius, and in addition, inner cut lines located between the extreme cut lines, are finished with third roundings defined by a radius, wherein the first roundings, the second roundings and the third roundings are directed to the outside of the base surface of the flap.

### SUMMARY

The purpose of the present solution is the design of a package with an opening covered by resealable label flap with increased reliability and closure durability.

The core of the construction of a package comprising, according to the invention, a container body having a top surface, a dispensing opening on said top surface, and a rigid reinforcing element adhered to the top surface of the container body and surrounding the dispensing opening, said reinforcing element being preferably in the form of a sheet of PET or OPS or PP foil, wherein said reinforcing element has a closing flap which can cover tightly the dispensing opening, said closing flap having a base surface and being a fragment of the reinforcing element separated by long cut lines running towards a hinge line, said long cut lines passing at least along two sides of the reinforcing element and having end fragments rounded to the outside of the base surface of the flap thereby forming roundings defined by a radius R1, wherein the hinge line is formed by a series of short cut lines passing between the end fragments of said long cut lines, said series of short cut lines comprising extreme cut lines and inner cut lines, wherein the extreme cut lines in said series of short cut lines, on the side of said long cut lines, have first roundings defined by a radius falling within 0.4 of the radius of the roundings of the end fragments of said long cut lines, whereas the opposite ends of the extreme cut lines have second roundings defined by a radius R3 falling within 0.2 of the radius of the roundings R1 of the end fragments of said long cut lines, and in addition, inner cut lines located between the extreme cut lines, are finished with third roundings defined by a radius R4 falling within 0.2 of the radius of roundings R1 of the end fragments of said long cut lines, wherein the first roundings, the second roundings and the third roundings are directed to the outside of the base surface of the flap. According to the other essential quality of the invention, said long cut lines define a pull ring located opposite the series of short cut lines within the reinforcing element. According to the another essential quality of the invention, an elastic top element, preferably in the form of a sheet of BOPP film is adhered to the reinforcing element, said flap being made of fragments of the reinforcing element and the top element that are glued together. According to the another essential quality of the invention, said long cut lines define a pull ring located opposite the series of short cut lines within the combination of the reinforcing element with the top element.

The advantageous effect of using the invention is very effective protection of the flap against its detachment from the remaining part of reinforcing element and the possibility of keeping the flap in a vertical position due to appropriate hinge design.

### BRIEF DESCRIPTION OF THE DRAWINGS

The subject of the solution will be clarified in details by means of its exemplary embodiments illustrated in drawings, in which:

FIG. 1 shows an axonometric view of an exemplary package;

FIG. 2a shows a detail of one of the possible variants of a combination of the body and the reinforcing element;

FIG. 2b shows a detail of another variant of a combination of the body and the reinforcing element with the top element;

FIG. 3 shows a detail showing an example of relationship between long cut lines and short cut lines;

FIG. 4 shows a detail showing the relationships between roundings of long cut lines and short cut lines;

FIG. 5 shows a figure formed by the sides of the reinforcing element in the package according to the first example;

FIG. 6 shows the figure formed by the sides of the reinforcing element in the package according to the second example;

FIG. 7 shows the figure formed by the sides of the reinforcing element in the package according to the third example;

FIG. 8 shows the figure formed by the sides of the reinforcing element in the package according to one of many possible modifications of the first example.

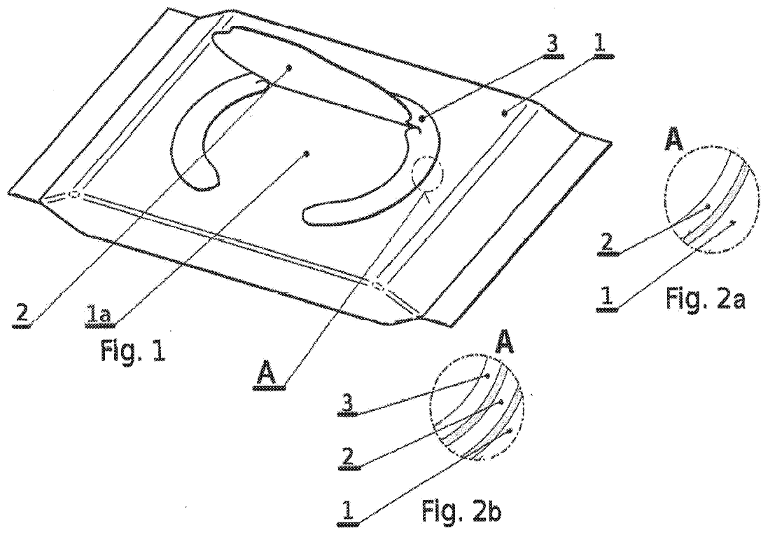

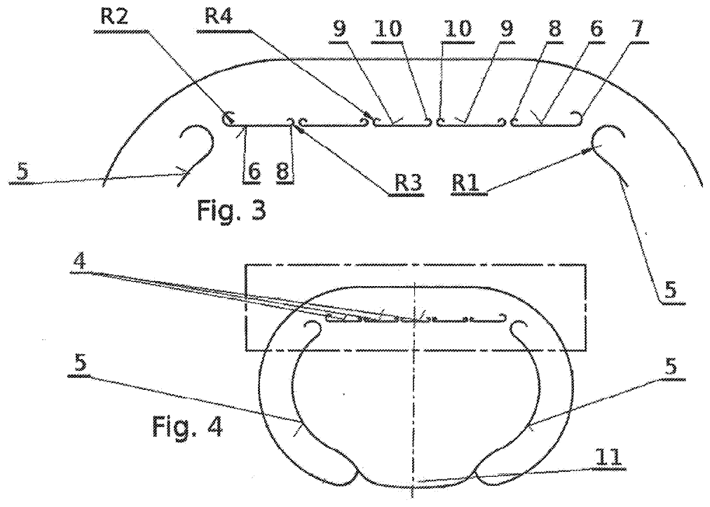

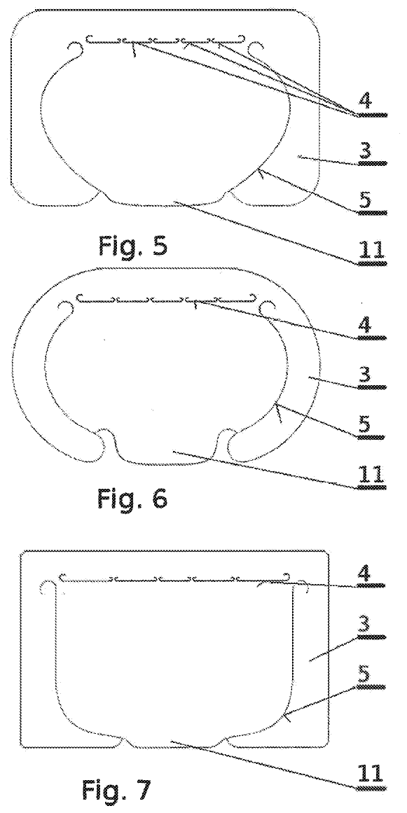

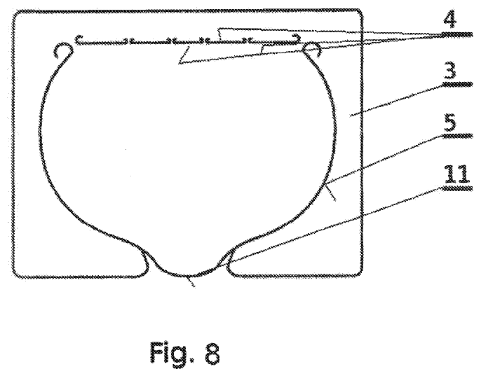

### DETAILED DESCRIPTION OF THE PREFERRED EMBODIMENTS

### Example 1

Package with an opening covered by resealable label flap according to the first embodiment of the invention comprises a container body 1 which has a dispensing opening on its top surface and a dispensing opening 1a and a rigid reinforcing element 2 adhered to the top surface of the container body in the form of a sheet of PET foil, as well as a flexible top element 3 adhered to the reinforcing element 2, in the form of a sheet of BOPP film and a flap covering tightly the dispensing opening 1a. The container body 1 is in the form of a foil sleeve with tightly closed ends. The sides of the combination of the reinforcing element 2 with the top element 3 form a figure similar in form to a rectangle with significantly rounded corners. The label flap consists of fragments of the reinforcing element 2 and the top element 3 adhered to each other, separated by long cut lines 5 running towards the hinge line 5, which pass along the two sides of the combination of the reinforcing element 2 with the top element 3. Long cut lines 5 run on curves that are a combination of arches with different radii. The hinge line 4 is formed by a series of short cut lines passing between the end fragments of long cut lines 5 rounded to the outside of the base surface of the flap, towards the sides of the combination of the reinforcing element 2 with the top element 3. Roundings of the end fragments of long cut lines 5 have a radius R1 of 2.5 mm in length. Extreme cut lines 6 present in a R2 falling within 0.4 of the radius of the roundings R1 of end fragments of long cut lines 5, while opposite ends of extreme cut lines 6 have second roundings 8 defined by a radius length R3 falling within 0.2 of the length of radius of roundings R1 of end fragments of long cut lines 5. Located between the extreme cut lines 6, inner cut lines 9 are finished with third roundings 10 with a length of radius R4 falling within 0.2 of length of the radius of roundings R1 of end fragments of long cut lines 5. First roundings 7, second roundings 8 and third roundings 10 are directed to the outside of the base surface of the flap, towards the side of the combination of the reinforcing element 2 with the top element 3. Within the side of the combination of the reinforcing element 2 with the top element 3 located opposite the series of short cut lines, long cut lines 5 separate the pull ring 11. Within the surface of pull ring 11, the adhesive bonding the container body 1 with the reinforcing element 2 is deactivated. The design does not exclude an option of using such materials as OPS or PS or PP or PE for the reinforcing element 2.

### Example 2

Package with an opening covered by resealable label flap according to the second embodiment of the invention comprises a container body 1 which has on its top surface a dispensing opening 1a and a rigid reinforcing element 2 in the form of a sheet of OPS foil adhered to the top surface of the container body and surrounding the dispensing opening 1a and the flap covering tightly the dispensing opening 1a. The container body 1 is in the form of a foil sleeve with tightly closed ends. The sides of reinforcing element 2 form an oval-like figure. The label flap is a fragment of the reinforcing element 2, separated by long cut lines 5 running towards the hinge line 5, which pass along the two sides of the reinforcing element 2. Long cut lines 5 run on curves that are a combination of arches with different radii. The hinge line 4 is formed by a series of short cut lines passing between the end fragments of long cut lines 5 rounded to the outside the base surface of the flap, towards the sides of the reinforcing element 2. Roundings of the end fragments of long cut lines 5 have a radius R1 of 2.5 mm in length. Extreme cut lines 6 present in a series of short cut lines, from the side of long cut lines 5, have first roundings 7 with radius length R2 falling within 0.4 of the length of the radius of roundings R1 of end fragments of long cut lines 5, while opposite ends of extreme cut lines 6 have second roundings 8 with a radius length R3 falling within 0.2 of the length of radius of roundings R1 of end fragments of long cut lines 5. Inner cut lines 9 located between the extreme cut lines 6 are finished with third roundings 10 with radius length R4 falling within 0.2 of the length of the radius of roundings R1 of end fragments of long cut lines 5. First roundings 7, second roundings 8 and third roundings 10 are directed to the outside of the base surface of the flap, towards the side of the reinforcing element 2. Within the side of reinforcing element 2 located opposite the series of short cut lines, long cut lines 5 separate the pull ring 11. Within the surface of pull ring 11, the adhesive bonding the container body 1 with the reinforcing element 2 is deactivated. The design does not exclude an option of using such materials as PET or PS or PP or PE for the reinforcing element 2.

### Example 3

Package with an opening covered by resealable label flap according to the third embodiment of the invention comprises a container body 1 which has on its top surface a dispensing opening 1a and a rigid reinforcing element 2 in the form of a sheet of PET foil adhered to the top surface of the container body and surrounding the dispensing opening 1a and the flap covering tightly the dispensing opening 1a. The container body 1 is in the form of a foil sleeve with tightly closed ends. The sides of reinforcing element 2 form a rectangle-like figure. The label flap is a fragment of the reinforcing element 2, separated by long cut lines 5 running towards the hinge line 5, which pass along the two sides of the reinforcing element 2. Long cut lines 5 run on curves that are a combination of a straight line with arches. The hinge line 4 is formed by a series of short cut lines passing between the end fragments of long cut lines 5 rounded to the outside the base surface of the flap, towards the sides of the reinforcing element 2. Roundings of end fragments of the long cuts 5 have a radius R1 of 2.5 mm in length. Extreme cut lines 6 present in a series of short cut lines, from the side of long cut lines 5, have first roundings 7 with radius length R2 falling within 0.4 of the length of the radius of roundings R1 of end fragments of long cut lines 5, while opposite ends of extreme cut lines 6 have second roundings 8 with a radius length R3 falling within 0.2 of the length of radius of roundings R1 of end fragments of long cut lines 5. Inner cut lines 9 located between the extreme cut lines 6 are finished with third roundings 10 with radius length R4 falling within 0.2 of the length of the radius of roundings R1 of end fragments of long cut lines 5. First roundings 7, second roundings 8 and third roundings 10 are directed to the outside of the base surface of the flap, towards the side of the reinforcing element 2. Within the side of reinforcing element 2 located opposite the series of short cut lines, long cut lines 5 separate the pull ring 11. Within the surface of pull ring 11, the adhesive bonding the container body 1 with the reinforcing element 2 is deactivated. The design does not exclude an option of using such materials as OPS or PS or PP or PE for the reinforcing element 2.

1. A package comprising a container body having a top surface, a dispensing opening on said top surface, and a rigid reinforcing element adhered to the top surface of the container body and surrounding the dispensing opening, said reinforcing element being preferably in the form of a sheet of PET or OPS or PP foil, wherein said reinforcing element has a closing flap which can cover tightly the dispensing opening, said closing flap having a base surface and being a fragment of the reinforcing element separated by long cut lines running towards a hinge line, said long cut lines passing at least along two sides of the reinforcing element and having end fragments rounded to the outside of the base surface of the flap thereby forming roundings defined by a radius (R1), wherein the hinge line is formed by a series of short cut lines passing between the end fragments of said long cut lines, said series of short cut lines comprising extreme cut lines and inner cut lines, wherein the extreme cut lines (6) in said series of short cut lines, on the side of said long cut lines (5), have first roundings (7) defined by a radius (R2) falling within 0.4 of the radius of the roundings (R1) of the end fragments of said long cut lines (5), whereas the opposite ends of the extreme cut lines (6) have second roundings (8) defined by a radius (R3) falling within 0.2 of the radius of the roundings (R1) of the end fragments of said long cut lines (5), and in addition, inner cut lines (9) located between the extreme cut lines (6), are finished with third roundings (10) defined by a radius (R4) falling within 0.2 of the radius of roundings (R1) of the end fragments of said long cut lines (5), wherein the first roundings (7), the second roundings (8) and the third roundings (10) are directed to the outside of the base surface of the flap.

2. The package according to claim 1, wherein the long cut lines (5) define a pull ring (11) located opposite the series of short cut lines within the reinforcing element.

3. The package according to claim 1, wherein an elastic top element (3), in the form of a sheet of BOPP film is adhered to the reinforcing element (2), said flap being made of fragments of the reinforcing element (2) and the top element (3) that are glued together.

4. The package according to claim 3, wherein the long cut lines define a pull ring (11) located opposite the series of short cut lines within the combination of the reinforcing element (2) with the top element (3).
